(19) United States
(12) Patent Application Publication
(10) Pub. No.: US 2025/0269609 A1
(43) Pub. Date: Aug. 28, 2025

(54) SEALING AND CUTTING DEVICE FOR FORMING FILTER-BAGS WITH INFUSION PRODUCTS

(71) Applicant: I.M.A. INDUSTRIA MACCHINE AUTOMATICHE S.p.A., Ozzano Dell'Emilia (Bologna) (IT)

(72) Inventors: Sauro RIVOLA, Ozzano Dell'Emilia (Bologna) (IT); Simone BADINI, Ozzano Dell'Emilia (Bologna) (IT); Dylan FORNI, Ozzano Dell'Emilia (Bologna) (IT)

(21) Appl. No.: 17/619,734

(22) PCT Filed: Jun. 23, 2020
(86) PCT No.: PCT/IB2020/055894

§ 371 Date: Dec. 16, 2021

(30) Foreign Application Priority Data
Jul. 1, 2019 (IT) 102019000010533

(51) Int. Cl. B29C 65/08; B29C 65/74; B65B 51/22; B65B 51/30

(52) U.S. Cl. CPC B29C 65/08; B29C 65/7451; B65B 51/225; B65B 51/30

(57) ABSTRACT

A sealing and cutting device for forming bags containing products includes; a sonotrode for sealing a portion of a continuous tubular strip, feeding along a feed direction; a counterhead positioned facing the sonotrode; a movement system for moving the sonotrode and/or anvil between a first non-operating position, wherein the sonotrode and the anvil are apart, and a second operating position wherein the sonotrode and the anvil are in contact to simultaneously seal a head and bottom of respective bags. A cutting element includes a circular blade connected to a supporting and movement element which imparts a translational movement to the blade with a circular shape along a direction perpendicular to the feed direction of the strip. The anvil includes a slit from which the blade 6 protrudes, for cutting the strip, by contact with the sonotrode in the second operating position, to separate a bag formed from the remaining strip.

### TECHNICAL FIELD

This invention relates to a sealing and cutting device for forming filter bags for infusion products, such as, for example, tea, coffee, chamomile and the like.

### BACKGROUND ART

The filter bags according to the invention may be of the so-called traditional type, that is to say, single-lobed or double-lobed filter bags (that is, with a flat extension) or also the pyramidal filter bags (that is, with a substantially three-dimensional extension).

Both types of filter bags have as common elements, as well as a piece of filter material paper and a dose of infusion product, a stretch of thread which is joined, on one side, to the piece of filter material and, on the other side, to a gripping tag.

The thread is usually positioned around the filter bag according to a predetermined path and associated with the filter bag with joining points (for example by sealing) of a differentiated type: strong points if the join must be maintained even during use or light points if that part of the thread has to be detached before use.

The machines for forming this type of filter bag may comprise in a prior art solution of the example type and as the base structure:
a wheel defining one or more work surfaces and rotating about its own axis in such a way as to define a working path having a circular feed direction;
a first feed station for depositing individual tags, in phase, on the cylindrical work surface in a predetermined zone of the working path;
a second feed station for feeding, along a weave path, a continuous thread on the cylindrical work surface, starting from a predetermined zone downstream of the zone for depositing the individual tags with reference to the feed direction; the above-mentioned weave path of the thread is also obtained thanks to the presence of protruding pins present on the cylindrical work surface;
a third feed station for feeding a continuous strip of filter material along the cylindrical work surface superposing the weave of thread and the tag and deposited downstream relative to the second feed station;
a first group of sonotrodes, interposed between the second and the third feed station, configured for making a first series of seals between the thread and the tag (in particular programmed to obtain strong type seals);
a second group of sonotrodes, positioned downstream of the first group of sonotrodes and at the cylindrical work surface in which the strip of filtering material is deposited; the second group of sonotrodes is configured to form both a plurality of seals between the stretch of thread, arranged according to the weave path and present under the strip of filter material, and the strip, and between the strip and the tag (in this case the second group of sonotrodes is configured to obtain light type seals);
a station for completion of the filter bag already provided with the tag and the thread, positioned downstream of the wheel, and configured for forming geometrically the filter bag (flat, pyramidal or tetrahedral shape), for introducing a dose of infusion product and closing the filter bag in its shape with an ultrasound device and separate the individual filter bags formed.

As already mentioned, in the current machines for forming the above-mentioned filter bags stations are used for forming the above-mentioned joining points and stations for sealing and cutting the filter bag formed with ultrasound devices.

In particular, the ultrasonic device used for sealing and cutting the filter bags formed is positioned downstream of the line for forming the filter bags and allows the simultaneous closing of the top of a filter bag formed and the bottom of a filter bag being positioned upstream of the previous filter bag relative to a feed direction of the strip of filter material.

The sealing and cutting device comprises:
a sonotrode for sealing the strip of filter material;
a counter-plate or anvil positioned facing the sonotrode;
a movement system connected to the sonotrode and to the anvil and configured for moving the sonotrode and the anvil between a first non-operating position, wherein sonotrode and anvil are spaced apart, and a second operating position wherein the sonotrode and anvil are in front contact for sealing the strip of filter material; the sonotrode and the anvil are moved transversely relative to the feed direction of the strip;
a cutting element or knife positioned on the anvil and able to separate the strip of filter material after sealing the strip; the cutting element is moved by means of movement means, synchronised with the movement of the sonotrode and the anvil, between a withdrawn non-operating position, wherein the cutting element is housed in the anvil, and an advanced operating position for cutting the strip of filter material, wherein the cutting element protrudes from the anvil and separates the strip of filter material.

In this solution, the sonotrode has a C-shaped cross-section to define, on one side, the sealing of the top of a filter bag already provided with the dose of product and, on the other hand, the bottom of a next filter bag to be formed.

The groove present in the centre of the sonotrode allows the insertion of the knife during the step of cutting the strip of filter material, that is, the two filter bags being formed, with a scissor-like action.

However, this technical solution has some drawbacks.

The combination between a linear knife and the groove of the sonotrode to perform a sort of scissor cut causes rapid wear of the cutting part of the knife.

The wear of the knife also increases further due to the high elasticity of some materials used in the formation of filter bags, in particular the so-called “woven-non-oven” materials.

To this must be added the fact that, in order to obtain a precise and good quality cut with this solution, it is necessary to deactivate the sonotrode during the cutting step to prevent the vibrations from determining an incorrect cutting line. This requires an overall slowing down of the steps and a greater stress of the components of the sonotrode.

### DISCLOSURE OF THE INVENTION

The aim of this invention is to provide a sealing and cutting device for forming filter bags with infusion products, such as, for example, tea, coffee, camomile and the like, which overcomes the above-mentioned drawbacks.

In particular, the aim of the invention is to provide a sealing and cutting device for forming filter bags with infusion products, such as, for example, tea, coffee, camomile and the like, which is able to improve the final quality of the filter bags.

A further aim of the invention is to provide a sealing and cutting device for forming filter bags with infusion products, such as, for example, tea, coffee, camomile and the like, which is able to increase the operating life of the components forming the device and, at the same time, reduce the times for forming the filter bags.

Said aims are fully achieved by the sealing and cutting device for forming filter bags with infusion products, such as, for example, tea, coffee, chamomile and the like, according to this invention as characterised in the appended claims.

### BRIEF DESCRIPTION OF DRAWINGS

The technical features of the invention will become more apparent from the following detailed description of a preferred, non-limiting embodiment of it, illustrated by way of example in the accompanying drawings, in which:

FIG. 1 is a schematic front view, with some parts cut away to better illustrate others, of a device for sealing and cutting for forming filter bags for infusion products according to this invention;

FIG. 2 is a perspective view of a scaled-up detail of a sonotrode and an anvil forming part of the sealing and cutting device of FIG. 1;

FIG. 3 is a front perspective view of the anvil of the cutting device;

FIGS. 4 and 5 are perspective views, with some parts cut away to better illustrate others, of the sonotrode and anvil unit in a non-operating position and with a cutting element positioned on the anvil in two different operating positions;

FIG. 6 is a perspective view of the movement unit of the cutting element of the previous drawings;

FIG. 7 is a cross section of the movement unit of the cutting element of FIG. 6.

### DETAILED DESCRIPTION OF PREFERRED EMBODIMENTS OF THE INVENTION

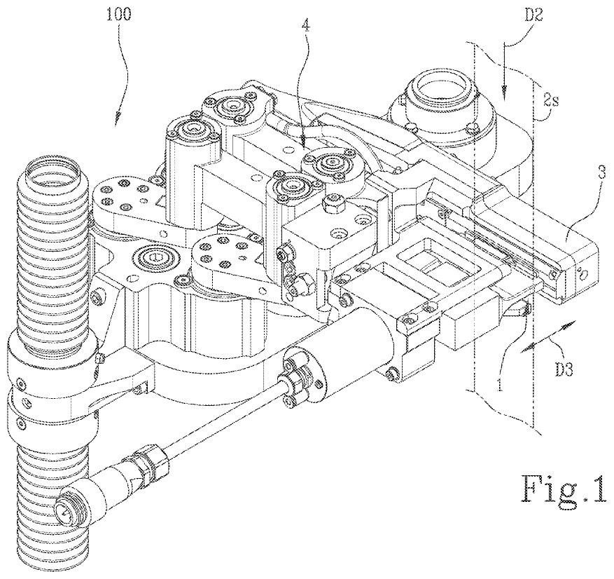

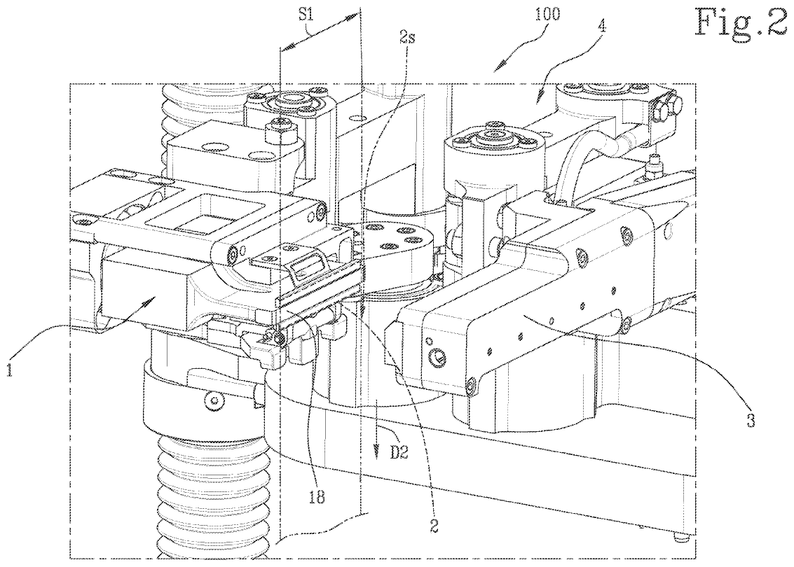

With reference to the accompanying drawings, and in particular to FIGS. 1 and 2, the device according to the invention, labelled 100 in its entirety, is used for sealing (by ultrasound) and cutting so as to form bags containing products of different types.

In the case illustrated, purely by way of a non-limiting example, the formation of filter bags for infusion products is described.

Therefore, again by way of example, the sealing and cutting device 100 may be used on machines (not illustrated) for forming filter bags configured to form both the three-dimensional filter bags such as the pyramid bags and the so-called traditional single-lobed or double-lobed bags with a rectangular shape.

Each bag is obtained with a piece of material containing at least one dose of product. In the case of filter bags, each filter bag is obtained with a piece of filter material containing a dose of infusion product.

Described below is the bag to be joined and cut from by device according to the invention, such as a filter bag obtained with filter material, but the solution according to the invention may be applied any other type of bag containing a product without limiting the scope of the solution.

The sealing and cutting device 100 comprises a sealing head 1 or sonotrode configured for sealing a portion 2 of a continuous tubular strip 2s of filter material (illustrated with a dashed line in FIGS. 1 and 2), feeding along a feed direction D2 (in such a way as to define a closed head of a first filter bag already provided with a dose of product and the bottom of a second filter bag being formed upstream of the first relative to the feed direction D2).

The direction of feed of the strip 2s may be along a vertical plane, a horizontal plane or an inclined plane depending on the type of forming machine on which the device 100 is applied.

The sealing and cutting device 100 comprises a counterhead or anvil 3 positioned facing the sonotrode 1.

The anvil 3 has a box-shaped structure with a length (or main longitudinal extension) at least equal to or greater than the length of the sonotrode 1.

The sealing and cutting device 100 comprises a movement system 4 connected to the sonotrode 1 and/or to the anvil 3 and configured for moving the sonotrode 1 and the anvil 3 (in a synchronised fashion) between a first non-operating position, wherein the sonotrode 1 and the anvil 3 are spaced apart, and a second operating position wherein the sonotrode 1 and the anvil 3 are in front contact for sealing the portion 2 of the strip of filter material, in such a way as to form a simultaneous sealing of a top and bottom of respective bags to be formed.

The sonotrode 1 and the anvil 3 are moved in a synchronised fashion along a direction D3 of movement transversal to the feed direction D2 of the continuous strip 2s of filter material.

The movement system 4 (connected to the sonotrode 1) comprises a plurality of kinematic mechanisms (such as pairs of connecting rods and cranks and relative drive units) which are able to synchronise the movement towards and away from the sonotrode 1 and the anvil 3.

The sealing and cutting device 100 comprises a cutting element 5 comprising a circular blade 6 connected to a supporting and movement element 8 which is able to impart a translational movement to the blade 6 with a circular shape along a direction D6 perpendicular to the feed direction D2 of the continuous tubular strip 2s.

It should be noted that the cutting element 5 is positioned on the anvil 3 and configured to cut the strip 2s of filter material, with the sonotrode 1 and the anvil 3 in the second operating position, in such a way as to separate the first filter bag formed from the remaining continuous strip 2s of filter material.

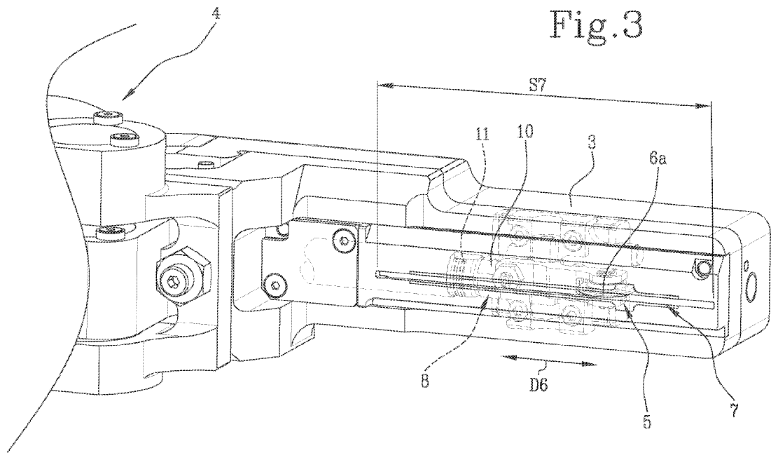

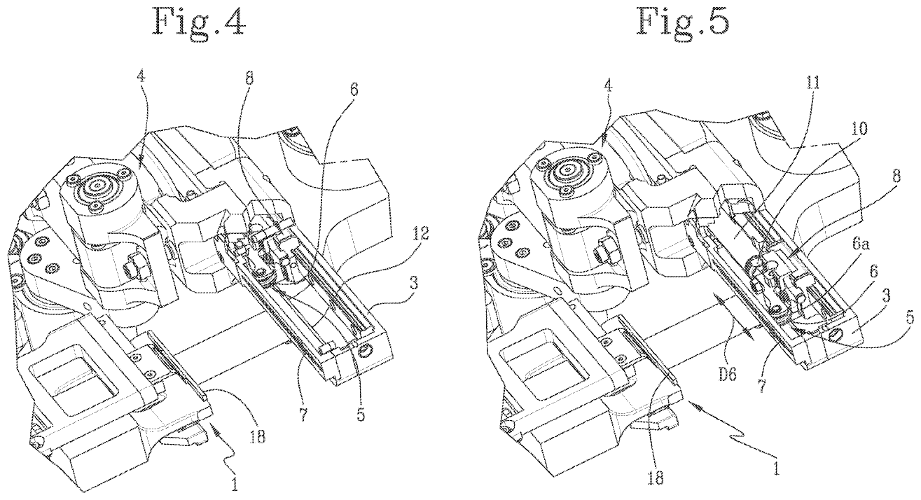

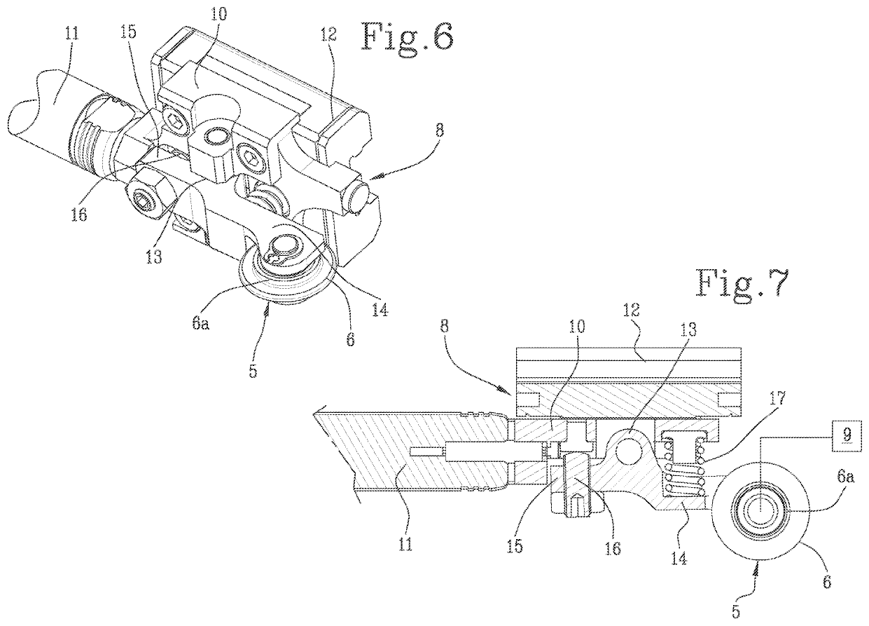

As illustrated also in FIGS. 3 to 7, the anvil 3 comprises a slit 7 from which the blade 6 protrudes, which is configured for cutting the tubular strip 2s, by contact with the sonotrode 1, whilst the sonotrode 1 and the anvil 3 are in the second operating position, in such a way as to separate a bag formed from the remaining continuous strip 2s.

According to a first embodiment, the cutting element 5 comprises a wheel 6a with a circular blade profile 6 articulated, and freely rotatable, with the movement and support unit 8 positioned inside the anvil 3.

According to a second embedment, the cutting element 5 comprises a wheel 6a with a circular blade profile 6 associated rigidly with the movement and support unit 8 positioned inside the anvil 3.

According to a third embodiment, the cutting element 5 comprises a wheel 6a with a circular blade profile 6 articulated with the movement and support unit 8 positioned inside the anvil 3.

In light of this, the wheel 6a is connected to an independent movement unit 9 configured to impart the forced rotation to the wheel 6a, at least during the translation movement of the blade 6 (irrespective of the contrast with the sonotrode 1).

The independent unit 9 is illustrated with a block in FIG. 7 and may consist of a drive unit or a kinematic coupling with a pinion-rack unit which is able to rotate the wheel 6 when the movement and support means 8 are activated.

Preferably, the movement and support unit 8 comprises a body 10 for supporting the wheel 6a connected to an actuator 11 configured for moving, in both directions, the supporting body 10 along the longitudinal extension of the anvil 3.

In light of this, the supporting body 10 is slidably connected to a linear guide 12 positioned inside the anvil 3 in such a way as to allow a rectilinear stroke of translation in both directions of the wheel 6a.

Preferably, the supporting body 10 comprises a rocker 13 articulated in its central part to the supporting body 10.

The rocker 13 has a first arm 14 and a second arm 15.

The wheel 6a is articulated on the first arm 14 (on the free end of the first arm 14). A grub screw 16 for adjusting and counter-balancing in contact with the supporting body 10 is screwably connected on the second arm 15 in such a way as to adjust the operating position of the wheel 6a protruding from the slit 7.

In light of this, an elastic preloading element 17 (a spring) is interposed between the supporting element 8 (the supporting body 10) and the blade 6 (the first arm 14) and is able to keep the blade 6 in contact with the sonotrode 1 in the second operating position.

As illustrated, the sonotrode 1 comprises a contact surface 18, facing the anvil 3 with a flat and continuous profile on which the blade 6 with a circular profile can slide in such a way as to determine a cut of the tubular strip 2s of filter material by making contact with the contact surface 18.

Preferably, the anvil 3 has the slit 7 with a length S7 at least equal to the length S1 of the sonotrode 1 in the sealing zone (preferably, the slit 7 may have an extension greater than the extension of the sonotrode 1).

Preferably, the anvil 3 is made as a single piece.

Preferably, the sonotrode 1 and/or the blade 6 are made of hardened materials. The invention also provides a method for sealing and cutting bags (filter) containing infusion products.

The method comprises the following steps:
preparing a sealing head 1 or sonotrode configured for sealing a portion 2 of a continuous tubular strip 2s of filter material, feeding along a feed direction D2;
preparing a counterhead or anvil 3 positioned facing the sonotrode 1;
moving the sonotrode (1) and anvil (3) towards each other along a direction (D3) of movement transversal to the direction (D2) of feeding the continuous tubular strip (2s) of filter material, until contact with the tubular strip (2s) of filter material;
joining the portion 2 of the tubular strip 2s of filter material, by activating the sonotrode 1, in such a way as to achieve a simultaneous sealing of a head and of a bottom of respective bags to be formed (as in the case illustrated, a closed head of a first filter bag already provided with a dose of product and the bottom of a second filter bag being formed positioned upstream of the first relative to the feed direction D2);
cutting along the portion 2 of continuous tubular strip 2s of sealed filter material, using a cutting element 5, in such a way as to separate a filter bag formed from the remaining continuous tubular strip 2s of filter material; this cutting step comprises a translation of the cutting element 5 with the blade 6 in a circular shape along a direction D6 perpendicular to the feed direction D2 of the continuous tubular strip 2s.

As illustrated, the cutting step is performed by the blade 6 by contact on the sonotrode 1.

It should also be noted that the cutting step comprises a translation of the cutting element 5 with the blade 6 having a circular shape along a direction D6 perpendicular to the direction D3 of movement of the sonotrode 1 and the anvil 3.

It should be noted that the translation of the cutting element 5 occurs along the entire longitudinal extension of the sonotrode 1 and the anvil 3 to allow a secure and complete separation of the filter bag formed relative to the remaining strip of filter material.

Preferably, during the cutting step by the cutting element 5 with the blade 6 with a circular shape occurs during the sealing step of the activated sonotrode 1.

The preset aims with numerous advantages are achieved thanks to a machine structured in this way.

The presence of a circular blade (preferably rotating) makes it possible to increase the working life of the blade.

The presence of a flat sonotrode which defines a surface for contact with the circular blade increases the safety and precision of cutting the stretch of strip of filter material.

The presence of a circular blade which is movable along a linear trajectory along the extension of the sonotrode and anvil makes it possible to cut with the sonotrode switched on in such a way as to improve the times and allow a clean and precise cutting of the stretch of filter material without fraying the edges of the cut stretches.

1. A sealing and cutting device for forming bags containing products; the sealing and cutting device comprising:
a sealing head or sonotrode configured for sealing a portion of a continuous tubular strip, feeding along a feed direction;
a counterhead or anvil positioned facing the sonotrode;
a movement system connected to the sonotrode and/or to the anvil and configured for moving the sonotrode and/or the anvil between a first non-operating position, wherein the sonotrode and the anvil are spaced apart from each other, and a second operating position wherein the sonotrode and the anvil are in front contact for sealing the portion of the strip of filter material in such a way as to simultaneously seal a head and a bottom of respective bags to be formed;
a cutting element comprising a circular blade connected to a supporting and movement unit which is able to impart a translational movement to the blade with a circular shape along a direction perpendicular to the feed direction of the continuous tubular strip, characterised in that the anvil comprises a slit from which the blade protrudes, which is configured to cut the tubular strip, by contact with the sonotrode, whilst the sonotrode and the anvil are in the second operating position, from the remaining strip in the second operating manner, so as to separate a bag formed from the remaining continuous strip.

2. The device according to claim 1, wherein the cutting element comprises a wheel with a circular blade profile articulated, and freely rotatable, with the movement and support unit positioned inside the anvil.

3. The device according to claim 1, wherein the cutting element comprises a wheel with a circular blade profile associated rigidly with the movement and support unit positioned inside the anvil.

4. The device according to claim 1, wherein the cutting element comprises a wheel with a circular blade profile articulated with the movement and support unit positioned inside the anvil; the wheel being connected to an independent movement unit configured for imparting the forced rotation of the wheel, at least during the translation movement of the blade.

5. The device according to claim 2, wherein the movement and support unit comprises a body for supporting the wheel connected to an actuator configured for moving, in both directions, the supporting body along a longitudinal extension of the anvil; the supporting body being slidably connected to a linear guide positioned inside the anvil in such a way as to allow a rectilinear translation stroke in both directions of the wheel.

6. The device according to claim 2, wherein the supporting body comprises a rocker articulated centrally to the supporting body; the rocker having a first arm and a second arm; the wheel being articulated on the first arm; an adjusting grub screw being screwably connected on the second arm in contact with the supporting body in such a way as to allow an adjustment of the position of the wheel protruding from the slit;

7. The device according to claim 1, comprising an elastic element interposed between the support unit and the blade so as to keep the blade in contact with the sonotrode in the second operating position.

8. The device according to claim 1, wherein the sonotrode comprises a contact surface, facing the anvil with a flat and continuous profile on which the blade with a circular profile can slide in such a way as to determine a cut of the tubular strip by making contact with the contact surface.

9. The device according to claim 1, wherein the slit made on the anvil has a length at least equal to the length of the sonotrode in the sealing zone.

10. The device according to claim 1, wherein the anvil is made as a single piece.

11. The device according to claim 1, wherein the sonotrode and/or the blade are made of hardened materials.

12. A method for sealing and cutting bags containing products comprising the steps of:
a sealing head or sonotrode configured for sealing a portion of a continuous tubular strip, feeding along a feed direction;
preparing a counterhead or anvil positioned facing the sonotrode;
moving the sonotrode and anvil towards each other along a direction of movement transversal to the direction of feeding the continuous tubular strip of filter material, until contact with the tubular strip of filter material; then
sealing the portion of the tubular strip, by activating the sonotrode, in such a way as to simultaneously seal a head and a bottom of respective bags to be formed;
cutting along the portion of continuous sealed tubular strip, using a cutting element, in such a way as to separate a bag formed from the remaining continuous tubular strip, said cutting step comprising a translation of the cutting element with the blade in a circular shape along a direction perpendicular to the feed direction of the continuous tubular strip, characterised in that the cutting step is performed by the blade, by contact on the sonotrode.

13. The method according to claim 12, wherein the cutting step by the cutting element with the blade with a circular shape occurs during the sealing step of the activated sonotrode.

14. The method according to claim 12, wherein said continuous tubular strip is made of filter material and said product is an infusion product.
